(19) United States
(12) Patent Application Publication
(10) Pub. No.: US 2017/0178636 A1
(43) Pub. Date: Jun. 22, 2017

(54) METHOD AND ELECTRONIC DEVICE FOR JOINTLY PLAYING HIGH-FIDELITY SOUNDS OF MULTIPLE PLAYERS

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Shengtao ZHAO, Tianjin (CN)

(21) Appl. No.: 15/247,811

(22) Filed: Aug. 25, 2016

Related U.S. Application Data
(63) Continuation-in-part of application No. PCT/CN2016/088552, filed on Jul. 5, 2016.

(30) Foreign Application Priority Data
Dec. 18, 2015 (CN) 2015109743644

(51) Int. Cl. G10L 19/00; G10L 19/16; G10L 19/08

(52) U.S. Cl. CPC G10L 19/0017; G10L 19/08; G10L 19/167

(57) ABSTRACT

Disclosed are a data download method and a method and electronic device for jointly playing high-fidelity sounds of multiple players includes: receiving first sound data of a HIFI audio format and second sound data of a second audio format; transmitting the first sound data of the HIFI audio format to a first processor for decoding, decoding the second sound data of the second audio format, and converting the decoded second sound data into the second audio data of a PCM format; controlling the first processor to convert the second sound data of the PCM format into the second sound data of the HIFI audio format; and mixing and playing the first sound data and the second sound data of the HIFI audio format. The disclosure realizes reminder function while ensuring sound mixing joint playing of multiple paths of sound sources.

### CROSS REFERENCE TO RELATED APPLICATIONS

This application is a continuation-in-part of International Application No. PCT/CN2016/088552, filed on Jul. 5, 2016, which is based upon and claims priority to Chinese Patent Application No. 2015109743644, filed on Dec. 18, 2015, the entire contents of which are incorporated herein by reference.

### TECHNICAL FIELD

The present disclosure relates to the field of multimedia technologies, and in particular, to a method and electronic device for jointly playing high-fidelity (HIFI, High-Fidelity) sounds of multiple players.

### BACKGROUND

Currently, when an Android system plays music, if a prompt tone exists, the system may mix the prompt tone into a music which is playing, and then play them together. In other cases, for example, if a webpage containing a background music is launched while a music is played in the background, the music contained in the webpage and the music already played may be played together after being mixed in a mixer at this moment, these prompt tones can be played together with a second player due to that the Android system may play all music mostly in a 48 k 16 bit format, and in case that multiple sounds is played at the same time, the system can directly play the music in the same format via a channel after being mixed by a mixer.

However, when a HIFI music is played at the background, the format of tone sound (in a 48 k 16 bit format) or music to be played by the second player may be different from the format of the HIFI music being played at the background, due to incapability of direct sound mixing and in that case only a headset/headphone is available for audio output equipment, music of two or more different data formats cannot be played at the same time, so that when listening to HIFI music, the music which is currently played is interrupted due to the tone and webpage, thereby influencing normal playing of the music.

### SUMMARY

Embodiments of the present disclosure provide a method and electronic device for jointly playing high-fidelity (HIFI, High-Fidelity) sounds of multiple players, in order to solve the technical problem of incapability of playing multiple music formats along with HIFI music in the prior art.

In one aspect, an embodiment of the present disclosure provides a method for jointly playing HIFI sounds of multiple players, including: receiving first sound data of a HIFI audio format and second sound data of a second audio format, wherein the second audio format is one audio format except the HIFI format; transmitting the first sound data of the HIFI audio format to a first processor for decoding, decoding the second sound data of the second audio format and converting the decoded second sound data into the second audio data of a pulse-code modulation (PCM) format; controlling the first processor to convert the second sound data of the PCM format into the second sound data of the HIFI audio format; and mixing and playing the first sound data of the HIFI audio format and the second sound data.

In the other aspect, an embodiment of the present disclosure provides an electronic device, including: at least one processor; and a memory communicably connected with the at least one processor for storing instructions executable by the at least one processor, wherein execution of the instructions by the at least one processor causes the at least one processor to: receiving first sound data of a HIFI audio format and second sound data of a second audio format, wherein the second audio format is an audio format except the HIFI format; transmitting the first sound data of the HIFI audio format to a first processor for decoding, decoding the second sound data of the second audio format, and converting the decoded second sound data into the second audio data of a pulse coding modulation PCM format; controlling the first processor to convert the second sound data of the PCM format into the second sound data of the HIFI audio format; and mixing and playing the first sound data and the second sound data of the HIFI audio format.

In the other aspect, an embodiment of the present disclosure provides a non-transitory computer-readable storage medium storing executable instructions that, when executed by an electronic device, cause the electronic device to: receiving first sound data of a HIFI audio format and second sound data of a second audio format, wherein the second audio format is an audio format except the HIFI format; transmitting the first sound data of the HIFI audio format to a first processor for decoding, decoding the second sound data of the second audio format, and converting the decoded second sound data into the second audio data of a pulse coding modulation PCM format; controlling the first processor to convert the second sound data of the PCM format into the second sound data of the HIFI audio format; and mixing and playing the first sound data and the second sound data of the HIFI audio format.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flowchart of a method for jointly playing HIFI sounds of multiple players provided by some embodiments of the present disclosure;

FIG. 2 is another exemplary flowchart of a method for jointly playing HIFI sounds of multiple players provided by some embodiments of the present disclosure;

FIG. 3 is a schematic diagram for internal execution of the method for jointly playing the HIFI sounds of multiple players provided by some embodiments of the present disclosure;

FIG. 4 is a schematic structural diagram of an electronic device for jointly playing the HIFI sounds of multiple players provided by some embodiments of the present disclosure; and

FIG. 5 is a schematic structural diagram of an electronic device for jointly playing the HIFI sounds of multiple players provided by some embodiments of the present disclosure.

### DETAILED DESCRIPTION

The preferred embodiments of the present disclosure will be illustrated in conjunction with the following drawings. It should be appreciated that the preferred embodiments of the present disclosure are merely used for illustrating and explaining the present disclosure, rather than limiting it.

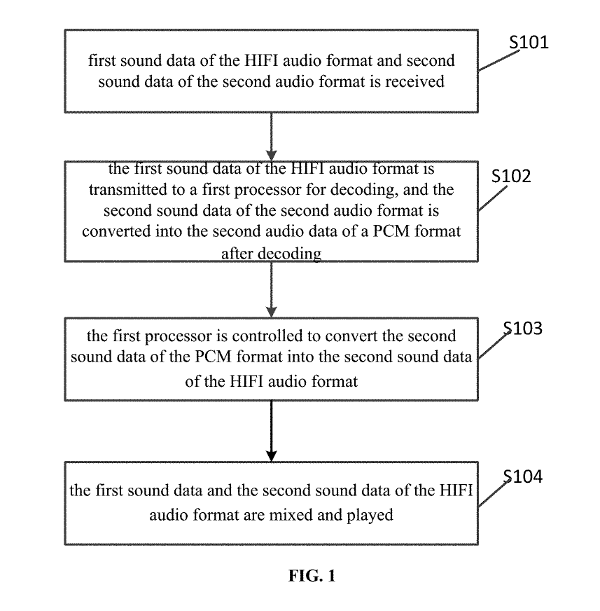

As shown in FIG. 1, the embodiment provides a method for jointly playing HIFI sounds of multiple players. The method is suitable for being deployed in a device in which it is required to play sounds in a HIFI format and other audio formats, such as a mobile phone. The method mainly includes: S101˜S104.

S101: first sound data of the HIFI audio format and second sound data of the second audio format is received.

Wherein, opening HIFI music to play or playing HIFI music is regarded as receiving the first sound data of the HIFI audio format.

Wherein the second audio format in the embodiment may represent one or more audio formats except the HIFI format, such as tone, music played in a webpage, or music of other formats. The second sound data may also be sound data of multiple audio formats. In short, because all sound data of the second audio format are processed by a same way in the embodiment, sound data of the all other audio formats except the HIFI format, which may be one or more types of sound data, are referred to as second sound data of the second audio format. Further, the sound data in the embodiment may also be music data, or may be other sounds, such as the sound of speech.

S102: the first sound data of the HIFI audio format is transmitted to a first processor for decoding, and the second sound data of the second audio format is converted into the second audio data of a PCM format after decoding.

In an alternative implementation, the first sound data of the HIFI format are directly transmitted to the first processor for decoding by a hardware decoding method, the second sound data of the second audio format are decoded by a software decoding method, and the decoded second sound data is converted into the second sound data of the PCM format.

Due to lower power consumption of the hardware decoding method as compared with that of the software decoding method, it's preferred to play the first sound data by using the hardware decoding method; however, for a device with good performance, a device of high energy storage capability, the first sound data may also be decoded by using the software decoding method.

Further, in consideration of the advantage of software decoding that multi-path simultaneous decoding and playing can be realized, it's preferred to use the software decoding method for decoding the second sound data of the second audio format. In the same way, if a device is provided with more hardware decoders, or only one type of sound data of the second format exists, the sound data of the second format may also be decoded by using the hardware decoding method.

S103, the first processor is controlled to convert the second sound data of the PCM format into the second sound data of the HIFI audio format.

The first processor normally decodes the first sound data of the HIFI format, and converts the second sound data of the PCM format into the second sound data of the HIFI format.

In consideration of the case that the HIFI is not a fixed type of audio format, but rather mainly refers to an audio format in which play is performed with maintaining sampling rate and bit width of the sound source, sound mixing processing in the embodiment requires that audio data flow involved in sound mixing should be decoded into the PCM format before being carried out, thus the second sound data require to be decoded into the PCM format, and then re-sampled in accordance with the source format of the first sound data which are playing currently, and sound mixing is performed on the first sound and the re-sampled second sound, therefore, the technical effect of playing after mixing can be achieved.

S104: the first sound data and the second sound data of the HIFI audio format are mixed and played.

The first sound data and the second sound data are both in the HIFI format after being processed by the above-described steps 102-103, and thus can be jointly played.

Wherein an alternative solution is to specially convert the second sound data in 102 into the second sound data of a 48 k 16 bit PCM format. It should be noted that the tone is sound data of the 48 k 16 bit PCM format after being decoded, thus conversion is not needed, but for sound data of other audio formats, such as sound data of the music format playing in a webpage, re-sampling is required to obtain the 48 k 16 bit PCM format after decoding.

In an alternative solution, the 104 is specially realized by the following steps: mixing the first sound data of the HIFI audio format and the second sound data; performing digital-to-analogue conversion on the first and second sound mixed data after mixing; and transmitting the converted first and second sound mixed data to a headphone for playing.

Due to only having one output device, the playing music format is only one, and in case that multiple paths of audio stream are played at the same time without sound mixing, only one path of audio stream can be normally played while other paths of audio stream are stopped. Therefore, the music which is played currently is interrupted due to playing of tone and webpage in the prior art, thereby influencing normal playing of music.

In the above method provided by the embodiment, because considering that play of tone or an owned sound of a webpage is only used for prompting existence of the webpage for a user or appearing of corresponding prompt information, in normal application scenarios, the user does not need to care about the audios which are jointly playing, so that the technical means that the sound data in the non-HIFI format are converted into sound data in the HIFI format, and then mixed into the HIFI sound data to be played is adopted, thus receiving tone or sound played when a webpage is opened while realizing enjoyment of HIFI music, as well as achieving the technical effect of realizing reminder function while ensuring sound mixing joint playing of multiple paths of sound sources.

Optically, the embodiment described above is more suitable for the situation with only one output apparatus, if more output apparatuses exist, the above method is still available. To be specific, for example, if two output apparatuses exist, one is used for playing HIFI audio and the other one is used for playing audio of other formats (that is, the above audio data of the second audio format), if audio of a third format needs to be played when HIFI audio is playing, the audio of the third format can be processed as the audio data of the second audio format in the above embodiment, so as to be jointly played with the HIFI audio.

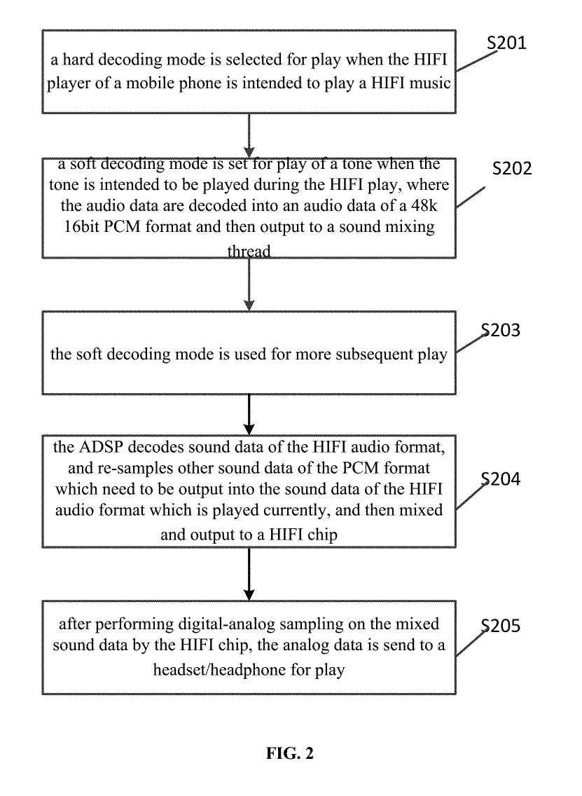

As shown in FIG. 2, the embodiment provides a method for jointly playing HIFI sounds of multiple players in conjunction with the schematic diagram as shown in FIG. 3, and the method includes: S201˜S205.

S201: a hardware decoding mode is selected for play when the HIFI player of a mobile phone is intended to play a HIFI music, where the audio data stream is directly output to an audio signal processing chip (ADSP) for decoding.

S202: a software decoding mode is set for play of a tone when the tone is intended to be played during the HIFI play, where the audio data are decoded into an audio data of a 48 k 16 bit PCM format and then output to a sound mixing thread, such as audioflinger mixer thread.

S203: the software decoding mode is used for more subsequent play, sound data, such as webpage music, is output to the audioflinger sound mixer threading.

All the sound data received by the audioflinger sound mixer thread is re-sampled and mixed into the 48 k 16 bit PCM format, and output to the audio signal processing chip (ADSP).

S204: the ADSP decodes sound data of the HIFI audio format, and re-samples other sound data of the PCM format which need to be output into the sound data of the HIFI audio format which is played currently, and then mixed and output to a HIFI chip.

S205: after performing digital-analog sampling on the mixed sound data by the HIFI chip, the analog data is send to a headset/headphone for play.

The method provided by the embodiment can be used for jointly playing music of the HIFI format and music of other formats without interrupting the play of music of the HIFI format, thus improving auditory experience of a user.

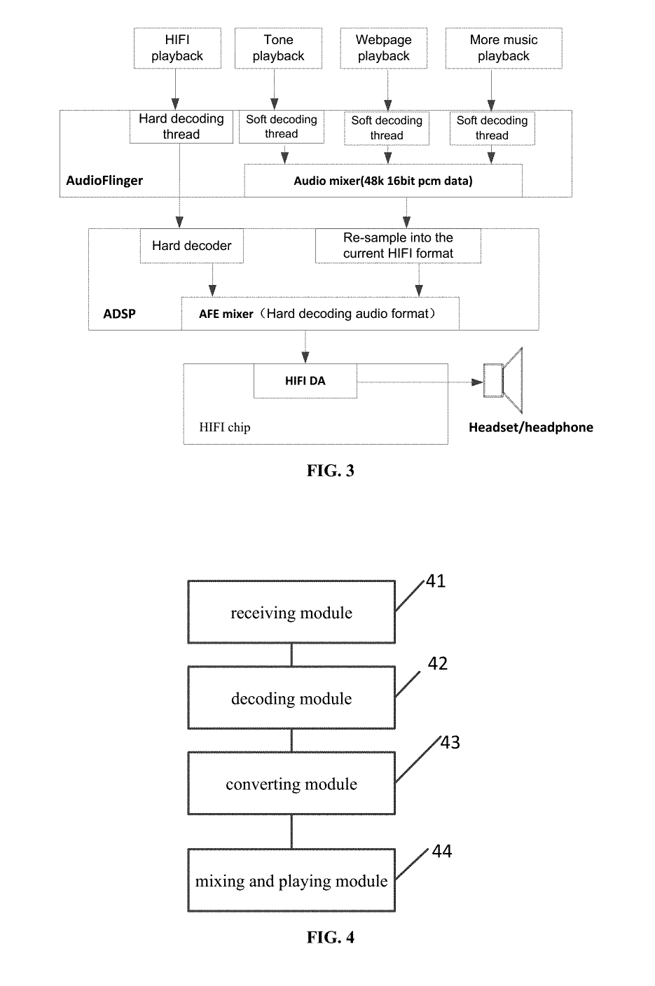

In order to facilitate realization of the method in the embodiment as shown in FIG. 1 or FIG. 2, as shown in FIG. 4, an embodiment further provides an electronic device for jointly playing HIFI sounds of multiple players. The electronic device is suitable for being installed on a terminal device which needs to play sound of multiple audio formats in addition to the HIFI format, such as a mobile phone. The electronic device includes: a receiving module 41, a decoding module 42, a converting module 43 and a mixing and playing module 44.

The receiving module 41 is configured to receive first sound data of the HIFI audio format and second sound data of a second audio format, wherein the second audio format is an audio format except the HIFI format;

The decoding module 42 is configured to transmit the first sound data of the HIFI audio format to a first processor for decoding, decode the second sound data of the second audio format, and convert the decoded second sound data into the second audio data of a PCM format.

The converting module 43 is configured to control the first processor to convert the second sound data of the PCM format into the second sound data of the HIFI audio format.

The mixing and playing module 44 is configured to mix and play the first sound data and the second sound data of the HIFI audio format.

Wherein, the decoding module 42 uses a hardware decoding mode for decoding the first audio data in the HIFI audio format. The decoding module 42 uses a software decoding mode for decoding the sound data in the second audio format.

Wherein, the PCM format is 48 k 16 bit PCM format.

Optionally, the mixing and playing module 44 includes: a mixing unit, configured to mix the first sound data and the second sound data in the HIFI audio format; a digital-to-analogue conversion unit, configured to perform digital-to-analogue conversion on the first and second sound mixed data after mixing; and a transmitting unit, configured to transmit the converted first and second sound mixed data to a headset/headphone for play.

Optionally, the first processor includes: an ADSP.

The electronic device provided by the embodiment is provided with a function of jointly playing sound data of the non-HIFI format and sound data of the HIFI format, thus, the technical effect that other sounds, such as a short message tone can be played without interruption of the playing HIFI music can be achieved.

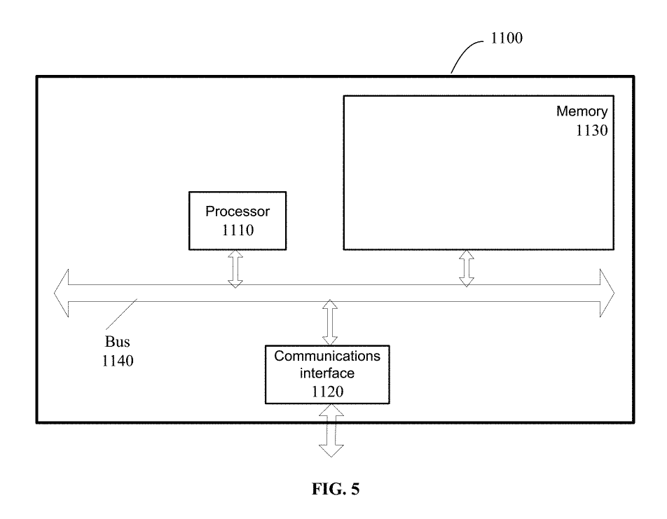

FIG. 5 illustrates a block diagram of a structure of the electronic device for jointly playing HIFI sounds of multiple players according to another embodiment of the present disclosure. The electronic device 1100 for jointly playing HIFI sounds of multiple players may be a host server, a personal computer (PC), or a portable computer or terminal, which has a computing capability. The specific embodiments of the present disclosure do not limit the specific implementation of a computing node.

The electronic device 1100 for jointly playing HIFI sounds of multiple players includes a processor 1110, a communications interface 1120, a memory 1130 and a bus 1140, where the processor 1110, the communications interface 1120 and the memory array 1130 communicate with one another via the bus 1140.

The communications interface 1120 is configured to communicate with a network element, wherein the network element includes a virtual machine management center, a shared memory and the like.

The processor 1110 is configured to execute a program. The processor 1110 may be a CPU (Central Processing Unit), or an ASIC (Application Specific Integrated Circuit) or one or more integrated circuits configured to implement the embodiments of the present disclosure.

The memory 1130 is configured to store a file. The memory 1130 may include a high-speed RAM memory, and may also include a non-volatile memory, such as a magnetic disk memory. The memory 1130 may also be a memory array. The memory 1130 may be divided into blocks, and the blocks are combined into a virtual volume according to a particular rule.

In one possible implementation, the above program may be program code containing computer operating instructions. The program is specially configured to perform the following steps: receiving a first sound data of a HIFI audio format and a second sound data of a second audio format, wherein the second audio format is one audio format except the HIFI format; transmitting the first sound data of the HIFI audio format to the first processor for decoding, decoding the second sound data of the second audio format, and converting the decoded second sound data into the second audio data of a PCM format; controlling the first processor to convert the second sound data of the PCM format into the second sound data of the HIFI audio format; and mixing and playing the first sound data of the HIFI audio format and the second sound data.

In one possible implementation, the hardware decoding mode is used to decode the first audio data of the HIFI audio format; and the software decoding mode is used for decoding the sound data of the second audio format.

In one possible implementation, the PCM format is 48 k 16 bit PCM format.

In one possible implementation, mixing and playing the first sound data of the HIFI audio format and the second audio format includes: mixing the first sound data in the HIFI audio format and the second sound data; performing digital-to-analogue conversion on the first and second sound mixed data after mixing; and transmitting the converted first and second sound mixed data to a headset/headphone for play.

In one possible implementation, the first processor includes: an audio signal processing chip (ADSP).

The embodiment of the present disclosure provides a non-transitory computer-readable storage medium storing executable instructions that, when executed by an electronic device, cause the electronic device to execute the processing method in the case of any method embodiment mentioned above.

Those skilled in the art should be understood that, the embodiment of the present disclosure can be provided as a method, a system or a computer program product. Therefore, the present disclosure may in form of a full hardware embodiment, a full software embodiment, or an embodiment of combination of software and hardware. Moreover, the present disclosure may also in form of a computer program product implemented on one or more computer usable storage media (includes but is not limited to a magnetic disk memory, an optical memory and the like) containing computer usable program code.

The present disclosure is described with reference to the flowchart and/or block diagram of the method, device (system) and computer program product. It should be understood that each flow and/or block of the flowchart and/or the block diagram as well as a combination of flows and/or blocks of the flowchart and/or the block diagram may be implemented by computer program instructions. These computer program instructions may be provided to a general-purpose computer, a dedicated computer, an embedded processor or processors of other programmable data processing device to generate a machine, such that an electronic device configured to implement functions of one or more flows in the flowchart and/or one block or more blocks in the block diagram may be generated by the instructions executed on a computer or processors of other programmable data processing apparatuses.

These computer program instructions may also be stored in a computer readable memory which can direct the computer or other programmable data processing devices to operate in a specific mode, so as to enable the instructions stored in the computer readable memory to generate a manufacture product containing an instruction apparatus. The instruction apparatus can implement the function designated in one or more flows in the flowchart and/or one block or more blocks in the block diagram.

These computer program instructions may also be loaded in a computer or other programmable data processing devices, so as to perform a series of operation steps on the computer or other programmable data processing devices to generate processing implemented by the computer, thus instructions executed on the computer or other programmable devices can provide steps for implementing functions designated by one flow or more flows in the flowchart and/or one block or more blocks in the block diagram.

Descriptions of the specific exemplary embodiments of the foregoing present disclosure are for the purposes of explanation and illustration. Theses descriptions are not intended to limit the present disclosure as the disclosed precise form, and apparently, various alterations and variations can be made according to the above teaching. Selection and description for the exemplary embodiments aim at the specific principle and practical applications of the specific principle explaining the present disclosure, such that those skilled in the art can realize and utilize various different exemplary embodiments in the present disclosure and various different selections and alterations.

The above described device embodiments are merely exemplary, wherein units for separation component explanation can be or cannot be separated physically, and components as unit display can be or cannot be physical units, namely, can be located on the same position, or can be distributed on multiple network units. Part or all modules can be selected to realize the purpose of the solution of the embodiment according to practical needs. Those skilled in the art can understand and implement without creative effect.

What is claimed is:

1. A method for jointly playing HIFI sounds of multiple players, executed by an electronic device, comprising:
receiving first sound data of a HIFI audio format and second sound data of a second audio format, wherein the second audio format is an audio format except the HIFI format;
transmitting the first sound data of the HIFI audio format to a first processor for decoding, decoding the second sound data of the second audio format, and converting the decoded second sound data into the second audio data of a pulse coding modulation PCM format;
controlling the first processor to convert the second sound data of the PCM format into the second sound data of the HIFI audio format; and
mixing and playing the first sound data and the second sound data of the HIFI audio format.

2. The method according to claim 1, wherein the first audio data of the HIFI audio format is decoded in a hardware decoding mode; and the sound data of the second audio format is decoded in a software decoding mode.

3. The method according to claim 1, wherein the PCM format is 48 k 16 bit PCM format.

4. The method according to claim 1, wherein mixing and playing the first sound data and the second sound data of the HIFI audio format comprises:
mixing the first sound data and the second sound data of the HIFI audio format;
performing digital-to-analogue conversion on the first and second sound mixed data after being mixed;
transmitting the converted first and second sound mixed data for playing.

5. The method according to claim 1, wherein the first processor comprises: an audio signal processing chip ADSP.

6. An electronic device, comprising:
at least one processor; and
a memory communicably connected with the at least one processor for storing instructions executable by the at least one processor, wherein execution of the instructions by the at least one processor causes the at least one processor to:
receiving first sound data of a HIFI audio format and second sound data of a second audio format, wherein the second audio format is an audio format except the HIFI format;
transmitting the first sound data of the HIFI audio format to a first processor for decoding, decoding the second sound data of the second audio format, and converting the decoded second sound data into the second audio data of a pulse coding modulation PCM format;
controlling the first processor to convert the second sound data of the PCM format into the second sound data of the HIFI audio format; and
mixing and playing the first sound data and the second sound data of the HIFI audio format.

7. The electronic device according to claim 6, wherein the first audio data of the HIFI audio format is decoded in a hardware decoding mode; and the sound data of the second audio format is decoded in a software decoding mode.

8. The electronic device according to claim 6, wherein the PCM format is 48 k 16 bit PCM format.

9. The electronic device according to claim 6, wherein execution of the instructions by the at least one processor causes the at least one processor to:
mix the first sound data and the second sound data of the HIFI audio format;
perform digital-to-analogue conversion on the first and second sound mixed data after being mixed;
transmit the converted first and second sound mixed data for playing.

10. The electronic device according to claim 6, wherein the first processor comprises: an audio signal processing chip ADSP.

11. A non-transitory computer-readable storage medium storing executable instructions that, when executed by an electronic device, cause the electronic device to:
receive first sound data of a HIFI audio format and second sound data of a second audio format, wherein the second audio format is an audio format except the HIFI format;
transmit the first sound data of the HIFI audio format to a first processor for decoding, decoding the second sound data of the second audio format, and converting the decoded second sound data into the second audio data of a pulse coding modulation PCM format;
control the first processor to convert the second sound data of the PCM format into the second sound data of the HIFI audio format; and
mix and playing the first sound data and the second sound data of the HIFI audio format.

12. The non-transitory computer-readable storage medium according to claim 11, wherein the first audio data of the HIFI audio format is decoded in a hardware decoding mode; and the sound data of the second audio format is decoded in a software decoding mode.

13. The non-transitory computer-readable storage medium according to claim 11, wherein the PCM format is 48 k 16 bit PCM format.

14. The non-transitory computer-readable storage medium according to claim 11, when the executable instructions is executed by an electronic device, cause the electronic device to:
mix the first sound data and the second sound data of the HIFI audio format;
perform digital-to-analogue conversion on the first and second sound mixed data after being mixed;
transmit the converted first and second sound mixed data for playing.

15. The non-transitory computer-readable storage medium according to claim 11, wherein the first processor comprises: an audio signal processing chip ADSP.
